(19) United States
(12) Patent Application Publication
(10) Pub. No.: US 2012/0281208 A1
(43) Pub. Date: Nov. 8, 2012

(54) CHAMBER FOR OPTICAL OBSERVATION, METHOD FOR OPTICALLY OBSERVING SAMPLE, AND METHOD FOR MANUFACTURING LOWER TRANSPARENT PLATE

(75) Inventors: Koji Matsuura, Okayama-shi (JP); Hiroaki Funahashi, Okayama-shi (JP)

(73) Assignee: NATIONAL UNIVERSITY CORP. OKAYAMA UNIVERSITY, OKAYAMA (JP)

(21) Appl. No.: 13/386,253

(22) PCT Filed: Jun. 24, 2010
(86) PCT No.: PCT/JP10/60748

§ 371 Date: Jan. 20, 2012

(30) Foreign Application Priority Data
Jul. 21, 2009 (JP) 2009-170605

(51) Int. Cl. G01N 21/01; B29C 39/02

(52) U.S. Cl. 356/244; 264/1.1

(57) ABSTRACT

A chamber for optical observation is provided which not only reduces evaporation of a sample put therein but also hardly adsorbs the sample, and allows more accurate evaluation of motility of the sample, and so on. The chamber for optical observation includes a lower transparent plate on which a sample is placed and an upper transparent plate which covers an upper side of the sample. The lower transparent plate is formed of a flexible material. When the sample is placed on a central portion of the lower transparent plate and covered with the upper transparent plate, the central portion of the lower transparent plate is depressed due to its own weight and the weight of the sample. In this state, a peripheral portion of the lower transparent plate comes into contact with the upper transparent plate, whereby the sample can be sealed with the upper transparent plate and the lower transparent plate.

### TECHNICAL FIELD

The present invention relates to a chamber for optical observation suitable for holding a sample when the sample is observed using optical observation means such as a microscope, a method for optically observing a sample using the chamber for optical observation, and a method for manufacturing a lower transparent plate for manufacturing the lower transparent plate in the chamber for optical observation.

### BACKGROUND ART

In recent years, quality improvement by means of artificial insemination is actively pursued for pig, cows, and other various livestock. Quality improvement of the livestock by means of artificial insemination intends to enhance improvement of livestock by selectively using semen of excellent livestock. For this purpose, semen for artificial insemination for use in quality improvement undergoes quality inspection before being introduced on the market. There are various criteria for evaluating semen in this quality inspection, and one of the important criteria is motility of sperms included in semen. A variety of apparatuses and methods for evaluating motility of semen are also proposed.

For example, a sperm activity evaluator is known, in which a light source and an optical sensor are arranged at opposing locations in a semen receiver (chamber) containing semen (Patent Document 1). This sperm activity evaluator determines the activity of sperms included in semen by applying weak light from the light source to the semen and then detecting the scattered light therefrom using the optical sensor. However, this sperm activity evaluator only shows the approximate number of sperms and the activity of a number of sperms as a whole and does not indicate the motility of individual sperms.

Therefore, in evaluation of semen for artificial insemination, it is still a common practice to observe semen with a microscope and evaluate motility of individual sperms included therein. However, the observation using a preparation is disadvantageous in that semen cannot be observed for a long time because moisture of the semen evaporates from the gap between a slide glass and a glass cover. In order to solve such a problem, Patent Document 2 proposes a preparation in which a sealing material is used to bond a peripheral portion of one surface of a cover glass and a lower member (for example, a slide glass) having a sample holding region. Patent document 2 also describes that a high polymer solution (silicone alcohol solution) having the siloxane bond in the main chain that has less effects on cells is preferable as the sealing material.

The preparation in Patent Document 2 can prevent evaporation of samples (for example, cells) but has the drawback of being unable to properly evaluate motility of sperms included in semen when it is used as a sample. The reason is that sperms are easily adsorbed on the slide glass or the cover glass, and the adsorption inhibits their motility.

In observation of semen with a microscope, a special chamber (well known one is “Makler Counting Chamber” manufactured by DIAGNOSTICS, INC., U.S. (Non-Patent Document 1)) is also used to contain semen. However, the chamber of this type is yet formed of glass, resin, or other similar material having a tendency to adsorb sperms and does not allow proper evaluation of motility of sperms as is the case with the use of a preparation. In addition, the special chamber has the drawbacks of being expensive and its limited availability.

Probably in view of such situations, traditionally, bovine serum albumin or other protein that hardly adsorbs sperms has been applied on the surfaces of slide glasses or cover glasses. This prevents sperms from being adsorbed on the slide glass or the cover glass, so that, advantageously, movement of sperms is not inhibited by those observation parts. However, it is not always easy to uniformly apply protein on the surface of the slide glass or the cover glass, often resulting in unevenness in some locations. Therefore, this unevenness may obscure the observed image and adversely affect evaluation of motility of sperms.

Now, Patent Document 3 describes a cell observation apparatus for a microscope in which a silicone film is arranged on a bottom surface of a chamber so that cells placed on the silicone film is observed. However, Patent Document 3 never mentions employment of semen as a sample or any device for preventing evaporation of a sample. Even if semen is put into the chamber of the cell observation apparatus for a microscope in Patent Document 3 and the top surface of the chamber is covered to prevent evaporation of the semen, the cover cannot make the semen thinly spread, making the thickness of semen uneven in some locations. Therefore, a number of sperms lie one on another or accurate focusing cannot be obtained for a microscope, which causes inconvenience of being unable to accurately evaluate motility of individual sperms.

### PRIOR ARTS

### Patent Documents

Patent Document 1: Japanese Patent Application Publication No. 2007-017417

Patent Document 2: Japanese Patent Application Publication No. 2004-229548

Patent Document 3: Japanese Patent Application Publication No. 2009-025630

### Non-Patent Documents

Non-Patent Document 1: “MAKLER COUNTING CHAMBER”, [Online], MidAtlantic DIAGNOSTICS, INC. [retrieved on Jun. 11, 2009], the website at <http://www.midatlanticdiagnostics.com/documentation/pdf/makler/MaklerCountingChamber.pdf>

### DISCLOSURE OF INVENTION

### Problems to be Solved by the Invention

The present invention is made to solve the aforementioned problem and provides a chamber for optical observation which not only reduces evaporation of a sample put therein but also hardly adsorbs the sample, and allows more accurate evaluation of motility of the sample, and so on. In particular, an object of the present invention is to provide a chamber for optical observation which can suitably be used for optically observing a sample including sperms included in semen or other substances easily adsorbed on glass or plastic. It is also an object of the present invention to provide a chamber for optical observation which has a simple structure readily manufactured, is available at a low price, and is easy to handle. It is also an object of the present invention to provide a method for observing a sample using this chamber for optical observation. It is yet another object of the present invention to provide a method for manufacturing a lower transparent plate for readily manufacturing the lower transparent plate of the chamber for optical observation.

### Means for Solving the Problem

The aforementioned problem is solved by providing a chamber for optical observation including a lower transparent plate on which a sample is placed and an upper transparent plate which covers an upper side of the sample. The lower transparent plate is formed of a flexible material. When the sample is placed on a central portion of the lower transparent plate and is covered with the upper transparent plate, the central portion of the lower transparent plate is depressed due to its own weight and the weight of the sample. In this state, a peripheral portion of the lower transparent plate comes into contact with the upper transparent plate, whereby the sample can be sealed with the upper transparent plate and the lower transparent plate.

Accordingly, it becomes possible to seal a sample with only two simple members, namely, the upper transparent plate and the lower transparent plate. Therefore, it is possible to provide a chamber for optical observation which is readily manufactured, is available at a low price, is easy to handle, and yet reduces evaporation of samples, so that semen or other evaporable samples can be observed for a long time. In the chamber for optical observation of the present invention, although the upper transparent plate does not require flexibility in particular, it is preferable that the upper transparent be formed of a flexible material as well. This can further enhance the sealing performance of the upper transparent plate and the lower transparent plate.

In the chamber for optical observation of the present invention, preferably, a leg portion is provided to protrude downward from the peripheral portion on a lower surface of the lower transparent plate, and with the sample being placed on the lower transparent plate, the central portion of the lower transparent plate is pressed down by its own weight of the lower transparent plate and the weight of the sample. Such a dent in the central portion of the lower transparent plate allows the sample to be suitably sealed with the upper transparent plate and the lower transparent plate even when the amount of bending of the upper transparent plate covering the sample is not large enough.

Here, the shape of the lower transparent plate in plain view is not specifically limited. However, it is preferable that the shape of the lower transparent plate in plain view be rectangle, ellipse, or any other shape in which a length in a certain direction and a length in another direction orthogonal to the certain direction are different, and that the leg portion be provided along the peripheral portion of the lower transparent plate. As an example of this case, the lower transparent plate is formed in a substantially rectangular shape in plain view, and the leg portion is formed in a substantially rectangular shape along the peripheral portion of the lower transparent plate. Accordingly, the space (sample holding region) for holding a sample in the lower transparent plate can acquire anisotropy. This helps to manipulate the moving direction of sperms included in the sample, thereby further facilitating evaluation of motility of sperms, as described later.

In the chamber for optical observation of the present invention, the material of the upper transparent plate and the lower transparent plate is not specifically limited as long as it is transparent and flexible. However, if the upper transparent plate or the lower transparent plate is formed of a material with poor hydrophobicity, the sample (for example, motile sperms) is easily adsorbed on the upper transparent plate or the lower transparent plate, which may prevent accurate observation of motility of the observation target, and so on. Therefore, preferably, at least one of the upper transparent plate and the lower transparent plate is formed of a material having a water contact angle of 70° or more. More preferably, the water contact angle of at least one of the upper transparent plate and the lower transparent plate is 80° or more and further preferably 90° or more.

A variety of such materials excellent in hydrophobicity can be used for the upper transparent plate and the lower transparent plate. However, when living bodies such as sperms or cells (motile substances) are included in samples, it is requested that at least one of the upper transparent material and the lower transparent material should be formed of a material that is not only hydrophobic but also does no harm on these living bodies. Specific examples of such materials include silicone elastomer having a siloxane bond as main chain. Silicone elastomer is suitably used as a material of at least one of the upper transparent plate and the lower transparent plate because it is transparent and flexible, in addition, does not adsorb sperms and the like with its excellent hydrophobicity, and does no harm on sperms and the like.

The aforementioned problem is also solved by providing a method for optically observing a sample sandwiched in a chamber for optical observation including a lower transparent plate and an upper transparent plate by optical observation means. The method includes covering the sample with the upper transparent plate formed of a flexible material, hanging down a peripheral portion of the upper transparent plate due to its own weight to come into contact with the lower transparent plate, observing the sample sealed with the upper transparent plate and the lower transparent plate. This method for optically observing a sample can be suitably performed by using the chamber for optical observation of the present invention mentioned above.

The aforementioned problem is also solved by providing a method for manufacturing a lower transparent plate for use in a chamber for optical observation including a lower transparent plate on which a sample is placed and an upper transparent plate which covers an upper side of the sample. The method includes, pouring transparent thermosetting resin in an uncured state into a lower transparent plate mold having a leg portion-forming recess, and thereafter heating the thermosetting resin together with the lower transparent plate mold for curing to form, with the leg portion-forming recess, a leg portion which protrudes downward from a peripheral portion on a lower surface of the lower transparent plate. Accordingly, the lower transparent plate in the chamber for optical observation of the present invention mentioned above can readily be manufactured at low cost. In addition, the lower transparent plates can readily be produced in large volume.

The lower transparent plate mold is not specifically limited as long as the leg portion-forming recess provided therein can yield the leg portion which protrudes downward from the peripheral portion on the lower surface of the lower transparent plate. However, preferably, the lower transparent plate mold has a plurality of minute grooves formed at the bottom of the leg portion-forming recess. Accordingly, the cured thermosetting resin (the lower transparent plate) can easily be removed from the lower transparent plate mold. Therefore, the method for manufacturing a lower transparent plate is more suitable for mass production. In addition, the lower transparent plate is hardly broken when being removed from the lower transparent plate mold, thereby improving yields.

### Effects of the Invention

As described above, the present invention provides a chamber for optical observation which not only reduces evaporation of a sample put therein but also hardly adsorbs the sample, and allows more accurate evaluation of motility of the sample, and the like. The chamber for optical observation according to the present invention can suitably be used, in particular, for optically observing a sample including sperms included in semen or other substance easily adsorbed on glass or plastic. The structure is simple and readily manufactured, is available at a low price, and is easy to handle. Furthermore, a method for observing a sample using the chamber for optical observation of the present invention can be provided. In addition, a method for manufacturing a lower transparent plate can be provided for readily manufacturing the lower transparent plate of the chamber for optical observation.

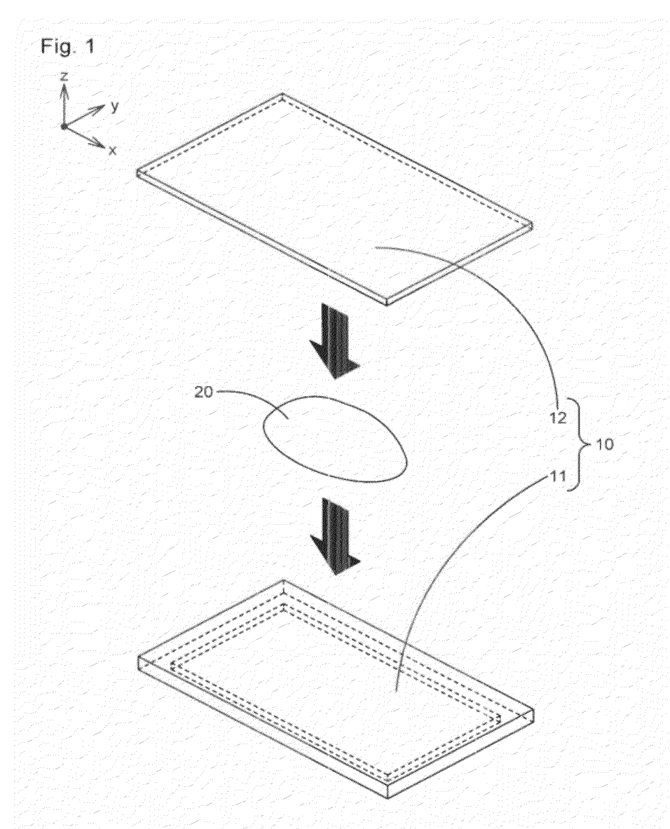

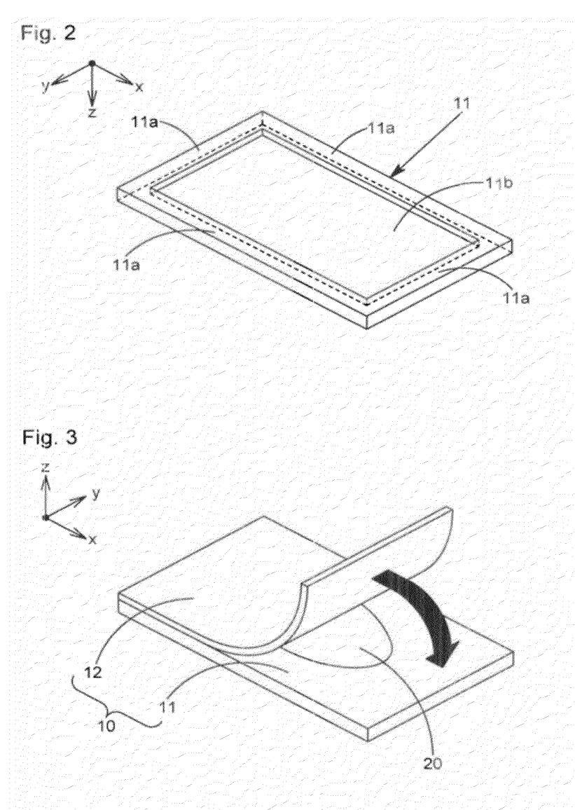

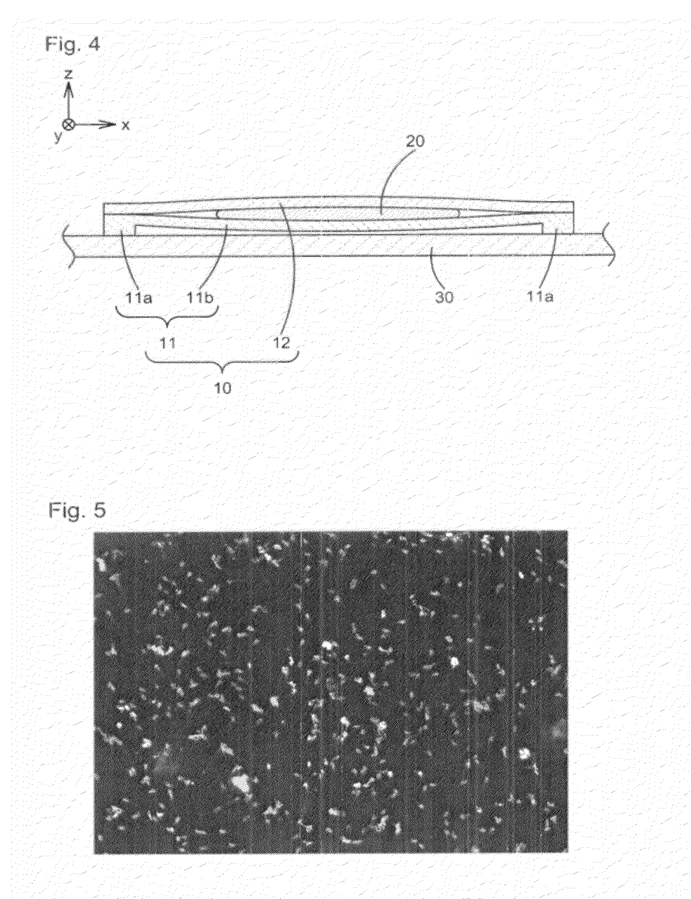

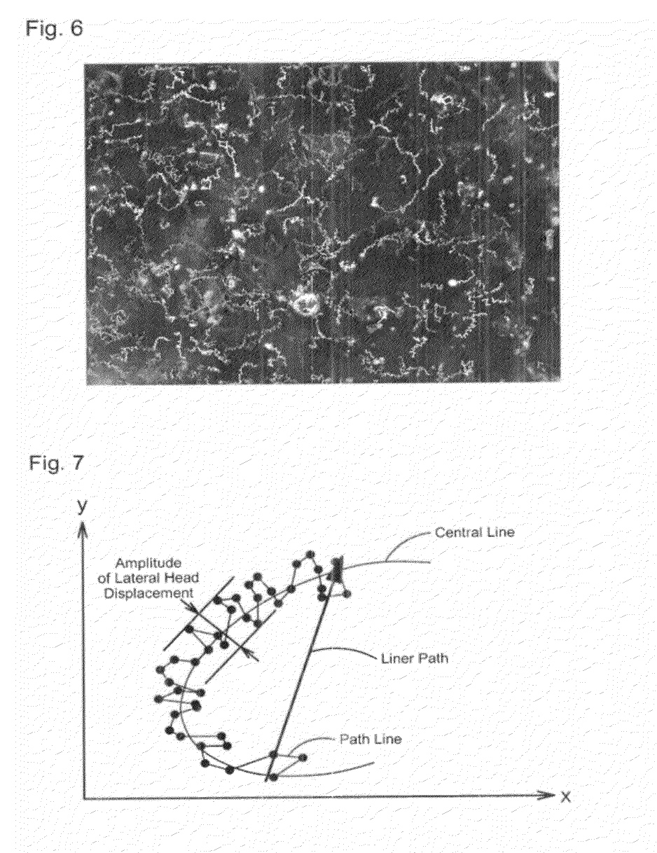

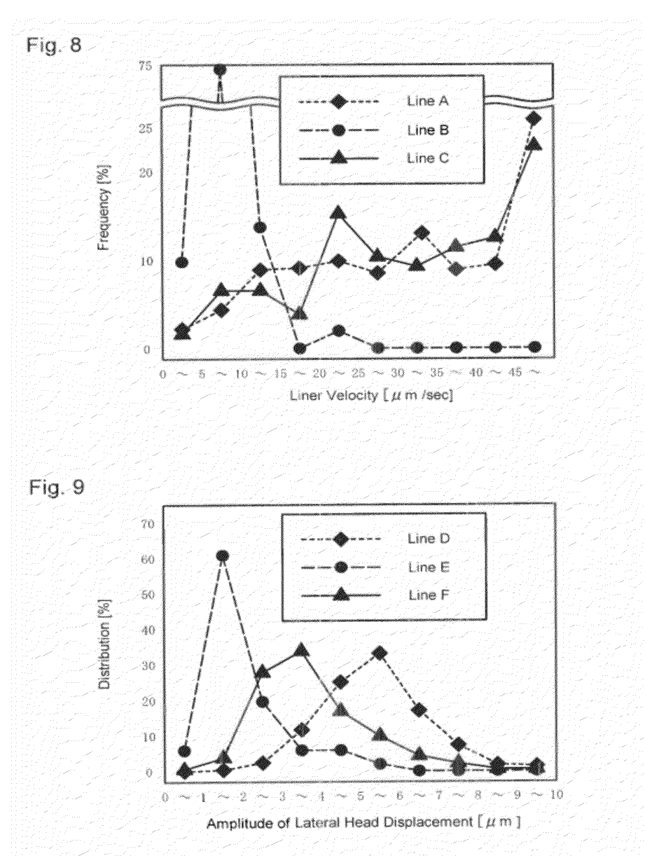

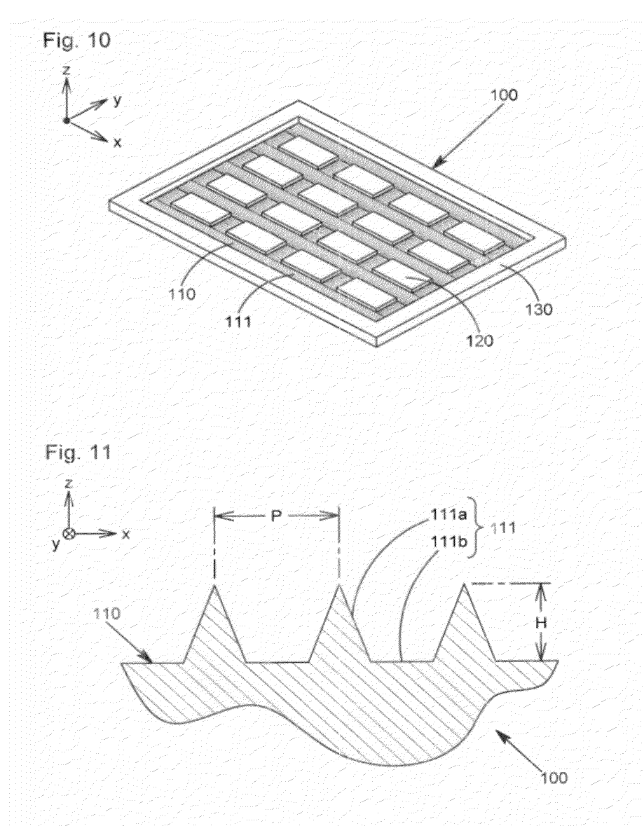

### BRIEF DESCRIPTION OF THE DRAWINGS

[FIG. 1] FIG. 1 is a perspective view showing a chamber for optical observation of the present invention, with a lower transparent plate and an upper transparent plate separated from each other.

[FIG. 2] FIG. 2 is a perspective view showing the state where the lower transparent plate of the chamber for optical observation of the invention is turned back.

[FIG. 3] FIG. 3 is a perspective view showing a process of sealing a sample in the chamber for optical observation of the invention.

[FIG. 4] FIG. 4 is a cross-sectional view schematically showing a sample sealed in the chamber for optical observation of the invention, taken along the center thereof.

[FIG. 5] FIG. 5 is a photograph of an image by a sperm motility analysis system which was captured at 15 minutes after a preparation of a comparative example.

[FIG. 6] FIG. 6 is a photograph of an image by the sperm motility analysis system which was captured at 15 minutes after a preparation of an example.

[FIG. 7] FIG. 7 is a diagram illustrating an algorithm for obtaining the linear velocity and the amplitude of lateral head displacement of a sperm, based on a path line of a motile substance.

[FIG. 8] FIG. 8 is a graph showing a distribution (line A) of linear velocity of the motile substance in a sample immediately after the preparation of the comparative example was prepared, a distribution (line B) of linear velocity of the motile substance in the sample at 15 minutes after the preparation of the comparative example was prepared, and a distribution (line C) of linear velocity of the motile substance in the sample at 15 minutes after the preparation of the example was prepared.

[FIG. 9] FIG. 9 is a graph showing a distribution (line D) of amplitude of lateral head displacement of the motile substance in the sample immediately after the preparation of the comparative example was prepared, a distribution (line E) of amplitude of lateral head displacement of the motile substance in the sample at 15 minutes after the preparation of the comparative example was prepared, and a distribution (line F) of amplitude of lateral head displacement of the motile substance in the sample at 15 minutes after the preparation of the example was prepared.

[FIG. 10] FIG. 10 is a perspective view showing a lower transparent plate mold for use to shape a lower transparent plate configuring the chamber for optical observation of the invention.

[FIG. 11] FIG. 11 is a cross-sectional view showing minute grooves at the bottom of a leg portion-forming recess of the lower transparent plate mold, taken along the plane vertical to the grooves.

### EMBODIMENTS FOR CARRYING OUT THE INVENTION

A suitable embodiment of a chamber for optical observation (optical observation chamber) of the present invention will be described in more detail using the drawings. FIG. 1 is a perspective view showing this optical observation chamber 10 of the present invention, with a lower transparent plate 11 and an upper transparent plate 12 separated from each other. FIG. 2 is a perspective view showing the state where the lower transparent plate 11 of the optical observation chamber 10 of the invention is turned back. FIG. 3 is a perspective view showing a process of sealing a sample 20 in the optical observation chamber 10 of the invention. FIG. 4 is a cross-sectional view schematically showing a sample 20 sealed in the optical observation chamber 10 of the invention, taken along the center thereof.

As shown in FIG. 1, the optical observation chamber 10 in this embodiment includes the lower transparent plate 11 on which the sample 20 is placed, and the upper transparent plate 12 which covers the upper side of the sample 20. The lower transparent plate 11 and the upper transparent plate 12 are both formed of a flexible material.

The material of the lower transparent plate 11 and the upper transparent plate 12 is not specifically limited as long as it has both transparency and flexibility. The material of the lower transparent plate 11 and the upper transparent plate 12 is determined as appropriate depending on the kind of the sample 20. The optical observation chamber 10 in this embodiment is designed for semen as the sample 20, and the lower transparent plate 11 and the upper transparent plate 12 are formed of silicone elastomer having a siloxane bond as main chain. Therefore, the lower transparent plate 11 and the upper transparent plate 12 are not only excellent in transparency and flexibility but also excellent in hydrophobicity to hardly adsorb a motile substance such as sperms (a glass-adsorbed material that is adsorbed on glass). Moreover, they do no harm on sperms or other living bodies.

Examples of a method for forming the lower transparent plate 11 and the upper transparent plate 12 include, but are not limited to, the following method.

[1] A liquid mixture of poly(alkylalkenylsiloxane) and a platinum compound (for example, TSE3032 (liquid A) manufactured by GE Toshiba Silicone Co., Ltd.) and a liquid mixture of poly(alkylalkenylsiloxane) and poly(alkylhydrogensiloxane) (for example, TSE3032 (liquid B) manufactured by GE Toshiba Silicone Co., Ltd.) are mixed at a predetermined ratio (for example, 10:1).

[2] The liquid mixture obtained in the [1] above is defoamed in a vacuum desiccator.

[3] The liquid mixture defoamed in the [2] above is formed into a thin film using a spin coater (for example, Opticoat MS-A100 manufactured by MIKASA CO., LTD.).

[4] A mold is adhered from above to the thin film obtained in the [3] above and thereafter put into an oven for heating at a predetermined temperature (for example, 70° C.) for a predetermined time (for example, one hour) for curing.

[5] The thin film cured in the [4] above is cut into a predetermined size.

This method is advantageous in that the lower transparent plate 11 and the upper transparent plate 12 can be shaped very easily.

Alternatively, the steps after the [3] above may be replaced by the following steps for shaping the lower transparent plate 11 and the upper transparent plate 12.

[3′] The liquid mixture defoamed in the [2] above is poured into a mirror-finished mold.

[4′] The mold containing the liquid mixture in the [3′] above is put into an oven for heating at a predetermined temperature (for example, 70° C.) for a predetermined time (for example, one hour) for curing.

[5′] The liquid mixture cured in the [4′] above in the form of a thin film is removed from the mold.

This method can suitably be used even when the lower transparent plate 11 or the upper transparent plate 12 has a complicated shape, for example, when the lower transparent plate 11 has a leg portion 11a as described later. If a hemocytometer is used as the mold used in the [3′] above, the grid of the hemocytometer can be transferred to the lower transparent plate 11 or the upper transparent plate 12, which is advantageous in that the movement of sperms can be analyzed even without a sperm motility analysis system described later.

In the optical observation chamber 10 of the present embodiment, the lower transparent plate 11 is shaped using a lower transparent plate mold 100 shown in FIG. 10 and FIG. 11 as the mold in the [3]′ above. FIG. 10 is a perspective view showing the lower transparent plate mold 100 for use to shape the lower transparent plate 11 configuring the optical observation chamber 10 of the present invention. FIG. 11 is a cross-sectional view showing minute grooves 111 at the bottom of a leg portion-forming recess 110 of the lower transparent plate mold 100, taken along the plane vertical to the grooves 111. The lower transparent plate mold 100 in the form of a board as shown in FIG. 10 has, on one surface thereof, the leg portion-forming recess 110 for forming the leg portion 11a at the periphery of the lower surface of the lower transparent plate 11 (see FIG. 2), central portion-forming protrusions 120 each for forming a depression in a central portion 11b of the lower surface of the lower transparent plate 11, and a frame 130 surrounding the outer circumference of the lower transparent plate mold 100. In the lower transparent plate mold 100 in the present embodiment, the leg portion-forming recess 110 is formed in a grid pattern, and the portion defined by the leg portion-forming recess 110 in a grid pattern serves as the central portion-forming protrusion 120. The leg portion-forming recess 110 forms five lines of grooves parallel to each other in the vertical direction and five lines of grooves parallel to each other in the horizontal direction. The central portion-forming protrusions 120, each having a rectangular shape in plain view, are formed in four rows and four columns. A single lower transparent plate mold 100 can produce sixteen lower transparent plates 11 at a time. However, the present invention is not limited to this manner, and the number of the grooves in the leg portion-forming recess 110 and the number of central portion-forming protrusions 120 to be formed can be changed as appropriate.

The lower transparent plate mold 100 is not specifically limited as long as it can shape uncured thermosetting resin. Preferably, the grooves serving as the leg portion-forming recess 110 are formed by performing cutting (for example, milling) on one surface of a metal plate. In this case, a number of minute grooves are formed at the bottoms of the cut grooves during cutting by a rotary cutting edge of a cutting device such as a milling cutter and are preferably left as they are without being subjected to mirror-finish. In this manner, a number of minute grooves left at the bottom of the groove reduce the contact area between thermosetting resin and the lower transparent plate mold 100, so that the bottom surface of the leg portion 11a of the lower transparent plate 11 is less likely to stick to the lower transparent plate mold 100. Therefore, the cured lower transparent plates 11 can easily be removed from the lower transparent plate mold 100. As shown in FIG. 10, also in the lower transparent plate mold 100 used in the present embodiment, a number of minute grooves 111 formed when the rotary cutting edge cuts the leg portion-forming recess 110 are left at the bottoms of the leg portion-forming recess 110.

The pitch P (the distance between the adjacent peaks 111a of minute grooves 111, see FIG. 11) and the height (depth) H (the height from the valley portion 111b of the minute groove 111 to the peak portion 111a, see FIG. 11) of the minute grooves 111 formed at the bottoms of the leg portion-forming recess 110 of the lower transparent plate mold 100 are not specifically limited. The pitch P and the height H can be changed by changing the shape or feed speed of the rotary cutting edge. However, since there is a limit to reduction of the pitch P of the minute grooves 111, the pitch P is usually set to 0.55 μm or more. The pitch P is preferably 1 μm or more and more preferably 2 μm or more. On the other hand, if the pitch P is too large, the uncured thermosetting resin intrudes into the valley portion 111b of the minute groove 111, which may rather make it difficult to remove the cured lower transparent plate 11 from the lower transparent plate mold 100. Therefore, the pitch P is usually set to 100 μm or less. The pitch P is preferably 50 μm or less and more preferably 20 μm or less. On the other hand, if the height H of the minute groove 111 is too low, the uncured thermosetting resin intrudes into the valley portion 111b of the minute groove 111, which may also make it difficult to remove the cured lower transparent plate 11 from the lower transparent plate mold 100. Therefore, the height H is usually set to 0.5 μm or more. The height H is preferably 1 μm or more and more preferably 2 μm or more. On the other hand, if the height H is too high, the peak portion 111a of the minute groove 111 may be fragile in strength. Therefore, the height H is usually set to 100 μm or less. The height H is preferably 50 μm or less and more preferably 20 μm or less.

The shape of the lower transparent plate 11 and the upper transparent plate 12 is not specifically limited. In the optical observation chamber 10 in this embodiment, as shown in FIG. 1, the lower transparent plate 11 and the upper transparent plate 12 are both shaped like a substantially rectangular plate. The upper transparent plate 12 has the flat top and bottom surfaces, whereas, as shown in FIG. 2, the lower transparent plate 10 has the leg portion 11a which protrudes from the other portions, at the periphery of the lower surface thereof. The leg portion 11a is provided annularly along the entire circumference of the four sides of the substantially rectangular-shaped lower transparent plate 11. This can facilitate sealing of the sample 20 with the lower transparent plate 11 and the upper transparent plate 12. More specifically, as shown in FIG. 4, with the sample 20 being placed on the central portion 11b of the lower transparent plate 11, the central portion 11b of the lower transparent plate 11 tends to be depressed downward due to its own weight and the weight of the sample 20, thereby facilitating close contact between the peripheral portion of the lower transparent plate 11 and the peripheral portion of the upper transparent plate 12. The upper transparent plate 12 covering the upper side of the sample 20 is bent along the top surface shape of the sample 20.

Here, if the sample 20 is thick and the highest point of the sample 20 protrudes higher than the peripheral portion of the lower transparent plate 11, as shown in FIG. 4, the peripheral portion of the upper transparent plate 12 hangs down to come into close contact with the peripheral portion of the lower transparent plate 11. Conversely, if the sample 20 is thin and the highest point of the sample 20 is lower than the peripheral portion of the lower transparent plate 11, the central portion of the upper transparent plate 12 is depressed downward while the peripheral portion of the upper transparent plate 12 in the elevated state comes into close contact with the peripheral portion of the lower transparent plate 11. In any case, the peripheral portion of the lower transparent plate 11 and the peripheral portion of the upper transparent plate 12 are in close contact with each other to prevent evaporation of the sample 20 sealed therein.

Furthermore, the substantially rectangular shape of the lower transparent plate 11 and the upper transparent plate 12 helps to manipulate the direction in which a motile substance (for example, sperms) included in the sample 20 moves, thereby further facilitating evaluation of motility of sperms. More specifically, as shown in FIG. 3, when the upper transparent plate 12 is put on the sample 20 from the x-axis negative side to the x-axis positive side, many sperms included in the sample 20 move from the x-axis negative side to the x-axis positive side. Then, the lower transparent plate 11 is formed in a substantially rectangular shape such that the longitudinal-axis direction thereof is matched with the direction in which the upper transparent plate 12 is put on, so that the movement of sperms can be observed for a long time.

The length of each side of the lower transparent plate 11 and the upper transparent plate 12 varies according to the kind of the sample 20 and the kind of the microscope to be used and is not specifically limited. Usually, each side is set at 5 to 50 mm and preferably about 10 to 30 mm. Each thickness of the lower transparent plate 11 and the upper transparent plate 12 varies according to the constituent material and is not specifically limited as far as their transparency and flexibility is not inhibited. The thickness is usually 10 μm to 2 mm, preferably 50 μm to 1 mm, more preferably 100 to 500 μm, and further preferably 150 to 300 μm. In the optical observation chamber 10 of the present embodiment, the lower transparent plate 11 and the upper transparent plate 12 both have the longitudinal length (the length in the y-axis direction in FIG. 1) of 15 mm, the lateral length (the length in the x-axis direction in FIG. 1) of 10 mm, and the thickness (the thickness of the central portion lib in the case of the lower transparent plate 11) of about 200 μm.

The size of the depression (observation portion) of the central portion 11b in the lower transparent plate 11 is also not specifically limited. However, if too small, the sample 20 can be observed only in a narrow range. Therefore, the length of the shorter side of the observation portion in the lower transparent plate 11 is usually set to 2 mm or more. The length of the shorter side of the observation portion is preferably 5 mm or more and more preferably 7 mm or more. For the same reason, the length of the longer side of the observation portion is usually set to 5 mm or more. The length of the longer side of the observation portion is preferably 6 mm or more and more preferably 7 mm or more. On other hand, if the size of the observation portion is too large, the amount of thermosetting resin to be used increases, which is uneconomical and moreover may cause inconvenience of, for example, making the observation portion of the lower transparent plate 11 to be easily broken. In addition, there is no much merit in terms of the ease of observation of the sample 20. Therefore, the length of the shorter side of the observation portion is usually set to 20 mm or less. The length of the shorter side of the observation portion is preferably 15 mm or less and more preferably 10 mm or less. For the same reason, the length of the longer side of the observation portion is usually set to 40 mm or less. The length of the longer side of the observation portion is preferably 30 mm or less and more preferably 20 mm or less.

The ratio (L₂/L₁) of the length (L₂) of the longer side to the length (L₁) of the shorter side of the depression (observation portion) of the central portion 11b in the lower transparent plate 11 is not specifically limited as long as it is greater than one. However, in order to manipulate the movement of sperms as described above, the ratio (L₂/L₁) is preferably 1.2 or greater. The ratio (L₂/L₁) is more preferably 1.5 or greater and further more preferably 1.7 or greater. On the other hand, too large a ratio (L₂/L₁) is meaningless. Therefore, the ratio (L₂/L₁) is usually set to 10 or less. The ratio (L₂/L₁) is preferably 5 or less and more preferably 3 or less. In the optical observation chamber 10 in the present embodiment, the length of the shorter side of the observation portion in the lower transparent plate 11 is 5 mm, where the ratio (L₂/L₁) is 2.

The height of the leg portion 11a of the lower transparent plate 11 varies, for example, depending on the size of the lower transparent plate 11, and is not specifically limited. However, if the leg portion 11a is too low, there is no meaning in providing the leg portion 11a. Therefore, the height of the leg portion 11a is usually set to 50 μm or more. The height of the leg portion 11a is preferably 100 μm or more and more preferably 150 μm or more. On the other hand, if the leg portion 11a is too high, the lower transparent plate 11 tends to be deformed into a distorted shape. In addition, the installation stability of the lower transparent plate 11 may become worse. Therefore, the height of the leg portion 11a is usually set to 1 mm or less. The height of the leg portion 11a is preferably 500 μm or less and more preferably 300 μm or less. In the optical observation chamber 10 in the present embodiment, the height of the leg portion 11a is about 200 μm.

The thickness (the thickness of the thickest part, which is applicable in the following) of the sample 20 sandwiched between the lower transparent plate 11 and the upper transparent plate 12 is also important. This is because if the sample 20 is too thin, the sample 20 may be absent in some places thereby precluding proper observation. Therefore, the thickness of the sample 20 is usually set to 5 μm or more and more preferably 100 μm or more. On the other hand, if the sample 20 is too thick, the sample 20 is present even at a place beyond the depth of field of optical observation means such as a microscope to be used, possibly resulting in an unclear observed image. Therefore, the thickness of the sample 20 is usually set to 1 mm or less. The thickness of the sample 20 is preferably 700 μm or less and more preferably 500 μm or less.

Next, in order to examine the effects of the optical observation chamber of the present invention, an experiment was conducted to evaluate the motility of each motile substance included in a sample, using a preparation (comparative example) prepared by sandwiching the sample between a slide glass and a cover glass and a preparation (example) prepared by sealing the sample in the optical observation chamber of the present invention. The water contact angle of the slide glass and the cover glass of the comparative example was about 30°. On the other hand, the water contact angle of the lower transparent plate and the upper transparent plate of the example of present invention was about 100°. In both of the comparative example and the example, pig semen (2 μL) diluted with HEPES-buffered Tyrode's lactate (TL-HEPES) culture containing polyvinyl alcohol (PVA) by a factor of five was used as the sample. Therefore, the “motile substance” referred to herein is “pig sperm”.

In this experiment, we examined how the preparation of the comparative example and the preparation of the example affected the linear velocity and the amplitude of lateral head displacement of sperms (motile substance). The linear velocity and the amplitude of lateral head displacement of sperms were obtained by placing each preparation of the comparative example and the example on a slide glass 30 (indicated by a reference numeral 30 in FIG. 4) on a microscope stage and by analyzing the image observed by the microscope using a sperm motility analysis system (SMAS) (KAGA ELECTRONICS CO., LTD.). The microscope for use may be an upright microscope (for example, a biological microscope CX41 manufactured by OLYMPUS CORPORATION), although an inverted microscope (ECLIPSE manufactured by Nikon Corporation) was used here. A 10× magnification objective lens (product name: BM10×A) manufactured by Nikon Corporation was used as a lens of the inverted microscope. A slide glass manufactured by Matsunami Glass Ind., Ltd. was used.

FIG. 5 is a photograph of an analysis image of the sperm motility analysis system which was captured at 15 minutes after the preparation of the comparative example was prepared. FIG. 6 is a photograph of an analysis image of the sperm motility analysis system which was captured at 15 minutes after the preparation of the example was prepared. In FIG. 5 and FIG. 6, the movement path of each sperm for one second immediately before the analysis image was captured is shown by a line. In the following, this line representing the movement path of a sperm is referred to as “path line”.

FIG. 7 is a diagram illustrating an algorithm for obtaining the linear velocity and the amplitude of lateral head displacement of a sperm based on the path line of a sperm (motile substance). As shown in FIG. 7, the sperm linear velocity was obtained by finding the length of the line (linear path) between the start point and the end point of the path line of a sperm and dividing the length of the linear path by the time required for the sperm to reach the end point from the start point (one second at maximum in this experiment). The linear velocities of sperms were obtained by this method and the distribution thereof was determined. The sperm amplitude of lateral head displacement was obtained by measuring the distance of the envelope of the path line, as shown in FIG. 7. The amplitude of lateral head displacements of sperms were obtained by this method and the distribution thereof was determined.

FIG. 8 is a graph showing:

a distribution (line A) of linear velocity of sperms (motile substance) in semen (sample) immediately after the preparation of the comparative example was prepared;

a distribution (line B) of linear velocity of sperms (motile substance) in semen (sample) at 15 minutes after the preparation of the comparative example was prepared; and

a distribution (line C) of linear velocity of sperms (motile substance) in semen (sample) at 15 minutes after the preparation of the example was prepared.

The distribution of linear velocity shown by the line A was obtained by finding the linear velocities of sperms by a method similar to the above-noted method, immediately after the preparation was prepared.

As can be seen from the line A in FIG. 8, sperms having slow linear velocities are very few, wherein about 2% sperms have linear velocities of less than 5 μm/s and about 4% sperms have linear velocities of less than 5 to 10 μm/s. In the line A, sperms having linear velocities of 10 to 15 μm/s, 15 to 20 μm/s, 20 to 25 μm/s, 25 to 30 μm/s, 30 to 35 μm/s, 35 to 40 μm/s, and 40 to 45 μm/s account for around 10% each, and sperms having linear velocities of 45 μm/s or more are present at as many as 25% or greater. The mean value of linear velocities of sperms was about 34.3 μm/s immediately after the preparation of the comparative example was prepared. This indicates that, even in the preparation of the comparative example, the sperms (motile substance) in semen (sample) were actively moving immediately after the preparation was prepared.

By contrast, as can be seen from the line B in FIG. 8, there is almost no sperm with linear velocities of 20 μm/s or more. Conversely, in the line B, sperms having linear velocities of 20 μm/s or less account for about 98%, and it is understood that there are only sperms with slow linear velocities. The mean value of linear velocities of sperms was about 7.9 μm/s at 15 minutes after the preparation of the comparative example was prepared. Although the same preparation was used, there was a great difference in distribution of sperm head linear velocities between the line A and the line B, presumably because the sperms were adsorbed over time on the slide glass or the cover glass of the preparation of the comparative example, and they could no longer move.

On the other hand, as can be seen from the line C in FIG. 8, the line C substantially conforms to the line A, and sperms with slow linear velocities are very few in the preparation of the example. The mean value of linear velocities of sperms was about 33.3 μm/s at 15 minutes after the preparation of the example was prepared, and no significant difference (P<0.05) was found when compared with the numerical value obtained immediately after the preparation of the comparative example was prepared. Although about 15 minutes elapsed since the preparation was prepared, almost no effect on the sperm linear velocity was found in the preparation of the example using the optical observation chamber of the present invention, presumably because almost no sperm was adsorbed on the lower transparent plate and the upper transparent plate of the optical observation chamber of the present invention, and the movement of sperms was not inhibited. Based on the results above, it was found that the optical observation chamber of the present invention can suitably be used for optically observing a sample including sperms included in semen or other substance easily adsorbed on glass or plastic.

FIG. 9 is a graph showing:

a distribution (line D) of amplitude of lateral head displacement of sperms (motile substance) in semen (sample) immediately after the preparation of the comparative example was prepared;

a distribution (line E) of amplitude of lateral head displacement of sperms (motile substance) in semen (sample) at 15 minutes after the preparation of the comparative example was prepared; and

a distribution (line F) of amplitude of lateral head displacement of sperms (motile substance) in semen (sample) at 15 minutes after the preparation of the example was prepared.

The distribution of amplitude of lateral head displacement indicated by the line D was obtained by finding the amplitude of lateral head displacements of sperms by a method similar to the above-noted method immediately after the preparation was prepared.

As can be seen from FIG. 9, the distribution (line F) of amplitude of lateral head displacement in the preparation of the example using the optical observation chamber of the present invention, at 15 minutes after the preparation was prepared, is generally shifted in a decreasing direction as compared with the distribution (line D) of amplitude of lateral head displacement in the preparation of the comparative example prepared by sandwiching the sample between the slide glass and the cover glass, immediately after the preparation was prepared, but is generally greater than the distribution (line E) of amplitude of lateral head displacement in the preparation of the comparative example, at 15 minutes after the preparation was prepared. The mean values of amplitude of lateral head displacements as indicated by the lines D, E, and F were 5.4 μm, 2.1 μm, and 3.7 μm, respectively. Based on the results above, it was also quantitatively confirmed that the optical observation chamber of the present invention could be used suitably for optically observing a sample including sperms included in semen or other substance easily adsorbed on glass or plastic.

The optical observation chamber of the present invention can suitably be used for observing a variety of samples. Among others, the use for observing living bodies (motile substance) such as sperms or cells is suitable. Sperms and cells are easily adsorbed on glass, and it is difficult to evaluate their motility with conventional preparations in which glass (slide glass or cover glass) is brought into contact with a sample. However, in the optical observation chamber of the present invention, glass-adsorbed materials such as sperms are less adsorbed on the lower transparent plate and the upper transparent plate. The optical observation chamber of the present invention can suitably be used for observing a glass-adsorbed material such as sperms. The optical observation chamber of the present invention can be used to observe sperms of pigs or other livestock as well as human sperms.

### DESCRIPTION OF REFERENCE NUMERALS

10 optical observation chamber

11 lower transparent plate

11a leg portion

11b central portion

12 upper transparent plate

20 sample

30 slide glass

100 lower transparent plate mold

110 leg portion-forming recess

111 minute groove

111a peak portion

111b valley portion

120 central portion-forming protrusion

130 frame

P pitch of groove

H height (depth) of groove

1. A chamber, comprising:
a lower transparent plate on which a sample is placed; and
an upper transparent plate which covers an upper side of the sample, wherein
the lower transparent plate is formed of a flexible material, and with the sample being placed on a central portion of the lower transparent plate and covered with the upper transparent plate,
wherein the central portion of the lower transparent plate is depressed due to a weight of the lower transparent plate itself and a weight of the sample, and in this state, a peripheral portion of the lower transparent plate comes into contact with the upper transparent plate to allow the sample to be sealed with the upper transparent plate and the lower transparent plate.

2. The chamber of claim 1, further comprising:
a leg portion, provided on a lower surface of the lower transparent plate so as to protrude downward from the peripheral portion on the lower surface of the lower transparent plate.

3. The chamber of claim 2, wherein the lower transparent plate is formed in a substantially rectangular shape in plain view, and the leg portion is formed in a substantially rectangular shape in plain view.

4. The chamber of claim 1, wherein the upper transparent plate is formed of a flexible material.

5. The chamber of claim 1, wherein at least one selected from the group consisting of the upper transparent plate and the lower transparent plate is formed of a material having a water contact angle of 70° or more.

6. The chamber of claim 5, wherein at least one selected from the group consisting of the upper transparent plate and the lower transparent plate comprises a silicone elastomer.

7. A method for optically observing a sample sandwiched in a chamber by optical observation element, the method comprising:
placing the sample on a central portion of a lower transparent plate of the chamber which is formed of a flexible material;
covering the sample with an upper transparent plate, with the central portion of the lower transparent plate being depressed due to the weight of the lower transparent plate itself and the weight of the sample; and
in this state, bringing a peripheral portion of the lower transparent plate into contact with the upper transparent plate for observing the sample sealed with the upper transparent plate and the lower transparent plate,
wherein the chamber is adapted for optical observation and comprises the lower transparent plate and the upper transparent plate.

8. A method for manufacturing a lower transparent plate the method comprising:
pouring a transparent thermosetting resin in an uncured state into a lower transparent plate mold having a leg portion-forming recess; and
thereafter heating the thermosetting resin together with the lower transparent plate mold, thereby curing the thermosetting resin to be in flexible state and to form, with the leg portion-forming recess, a leg portion which protrudes downward from a peripheral portion on a lower surface of the lower transparent plate,
wherein a lower transparent plate obtained is configured such that a central portion of the lower transparent plate depresses due to a weight of the lower transparent plate itself and a weight of a sample with the sample being placed on the central portion of the lower transparent plate, and
wherein the lower transparent plate is adapted for an optical observation chamber and the chamber comprises the lower transparent plate, on which a sample is placed, and an upper transparent plate which covers an upper side of the sample.

9. The method of claim 8, wherein the lower transparent plate mold has a plurality of minute grooves formed at the bottom of the leg portion-forming recess.

10. The chamber of claim 2, wherein the upper transparent plate is formed of a flexible material.

11. The chamber of claim 3, wherein the upper transparent plate is formed of a flexible material.

12. The chamber of claim 2, wherein at least one selected from the group consisting of the upper transparent plate and the lower transparent plate is formed of a material having a water contact angle of 70° or more.

13. The chamber of claim 3, wherein at least one selected from the group consisting of the upper transparent plate and the lower transparent plate is formed of a material having a water contact angle of 70° or more.

14. The chamber of claim 4, wherein at least one selected from the group consisting of the upper transparent plate and the lower transparent plate is formed of a material having a water contact angle of 70° or more.

15. The chamber of claim 10, wherein at least one selected from the group consisting of the upper transparent plate and the lower transparent plate is formed of a material having a water contact angle of 70° or more.

16. The chamber of claim 11, wherein at least one selected from the group consisting of the upper transparent plate and the lower transparent plate is formed of a material having a water contact angle of 70° or more.

17. The chamber of claim 5, wherein the upper transparent plate comprises a silicone elastomer.

18. The chamber of claim 5, wherein the the lower transparent plate comprises a silicone elastomer.

19. The chamber of claim 5, wherein the upper transparent plate and the lower transparent plate comprise a silicone elastomer.

20. The chamber of claim 5, wherein at least one selected from the group consisting of the upper transparent plate and the lower transparent plate consists essentially of a silicone elastomer.
